(19) United States
(12) Patent Application Publication
(10) Pub. No.: US 2026/0301756 A1
(43) Pub. Date: Oct. 1, 2026

(54) AUDIO DENOISING SYSTEM AND METHOD THEREOF FOR FINE-TUNING AN AUDIO DENOISING MODEL

(71) Applicant: LITE-ON TECHNOLOGY CORPORATION, TAIPEI CITY (TW)

(72) Inventors: Jia-Sin LIN, TAIPEI CITY (TW); Ting Yu LIU, TAIPEI CITY (TW); Zong-En WU, TAIPEI CITY (TW); Hsuan Yu SHIH, TAIPEI CITY (TW)

(21) Appl. No.: 19/372,720

(22) Filed: Oct. 29, 2025

Related U.S. Application Data
(60) Provisional application No. 63/777,032, filed on Mar. 25, 2025.

(51) Int. Cl. G10L 21/0216; G10L 21/0208; G10L 25/30

(52) U.S. Cl. CPC G10L 21/0216; G10L 25/30; G10L 2021/02087; G10L 2021/02163

(57) ABSTRACT

An audio denoising system includes an edge device and a server device. The edge device executes a local audio denoising model to process input audio signals. The server device receives audio samples from the edge device, detects audio events, identifies background noise segments, fine-tunes a corresponding server-side model using the noise segments, and transmits fine-tuned parameters to update the local model, thereby enhancing denoising performance in dynamic environments.

### CROSS REFERENCE TO RELATED APPLICATIONS

This application claims the benefit of U.S. provisional patent application No. 63/777,032, filed on March. 25, 2025, the entirety of which is incorporated by reference herein.

### TECHNICAL FIELD

The present disclosure relates to audio processing and machine learning, and in particular, to an audio denoising system and method thereof for fine-tuning an audio denoising model.

### BACKGROUND

Artificial intelligence (AI) models are typically trained as general-purpose systems prior to deployment, with the goal of maximizing overall average performance across diverse conditions. However, such generalized models may not achieve optimal results in every environment. Once an AI model has been fully trained and deployed on an edge device, the model parameters stored within the device are often difficult to modify. After an edge device product is released, optimizing the embedded AI model based on user-specific or environment-specific needs becomes challenging. Model updates may require users to follow complex procedures dictated by the manufacturer, which can hinder usability and limit post-deployment optimization.

In the context of audio denoising, model performance is highly dependent on whether the training dataset includes target noise types or acoustically similar noise. Ensuring sufficient diversity within the training dataset is difficult, and models may not maintain their expected performance levels when applied to unseen real-world environments. Although dataset diversity can be improved by extensive data augmentation, doing so typically increases the number of learnable parameters, thereby enlarging the model and slowing down inference.

For edge-based applications, computational resources and memory are inherently constrained. Therefore, model parameter growth cannot be unlimited merely for the sake of enhancing generalization. Conventional approaches to deploying AI models on edge devices often involve balancing between inference speed and denoising performance.

Therefore, a method or system for improving the performance of AI models deployed on edge devices is needed to address the above issues.

### BRIEF SUMMARY

An embodiment of the present disclosure provides an audio denoising system. The system comprises an edge device and a server device. The edge device comprises a microphone configured to acquire an audio sample from an environment. The edge device comprises a memory storing a local instance of an audio denoising model. The edge device comprises a processor configured to execute the local instance of the audio denoising model to denoise an input audio signal. The server device is configured to receive the audio sample from the edge device. The server device detects, from the audio sample, one or more audio events corresponding to a plurality of audio event categories. The server device identifies background noise segments in the audio sample based on the detected audio events. The server device fine-tunes a server-side instance of the audio denoising model corresponding to the local instance using the identified background noise segments to obtain fine-tuned model parameters. The server device transmits the fine-tuned model parameters to the edge device. The processor is further configured to update the local instance of the audio denoising model using the fine-tuned model parameters.

In some embodiments, the system includes a server device configured to detect one or more audio events within an audio sample. The server performs audio tagging on the audio sample to assign one or more audio event tags, each corresponding to a predefined audio event category.

In some embodiments, the server device identifies background noise segments by determining a union set of audio sample portions associated with the assigned audio event tags, computing a complement set comprising portions not included in the union set, and selecting the complement set as background noise segments.

In other embodiments, the server transmits the detected audio event tags to a user interface, receives user input indicating one or more tags to be treated as background noise, and selects the corresponding audio segments for use in fine-tuning an audio denoising model.

In some embodiments, the system further includes functionality for fine-tuning a server-side instance of an audio denoising model using background noise segments. The server device extracts audio feature embeddings from the background noise segments and applies a self-attention mechanism to the extracted embeddings. The self-attention mechanism is conditioned on a selected audio event category to emphasize audio feature representations relevant to that category, thereby enhancing the model's ability to suppress context-specific noise.

In some embodiments, the self-attention mechanism is utilized exclusively during server-side fine-tuning, while inference on an associated edge device is performed without the self-attention mechanism to reduce computational overhead.

In some embodiments, the system enables server-side fine-tuning of an audio denoising model by generating augmented training data. The server device creates the augmented training data by mixing identified background noise segments with audio recordings that correspond to foreground audio events. The model parameters of the audio denoising model are then updated based on the augmented data. In some embodiments, the server per-forms the mixing at multiple predefined signal-to-noise ratios (SNRs) to improve model robustness under varying noise conditions. Additionally, the server may generate the augmented training data by assembling a training corpus comprising paired clean reference audio and corresponding synthetic mixtures produced by combining the clean reference audio with the identified background noise segments.

In some embodiments, the system employs an audio denoising model based on a Deep Complex Convolution Recurrent Network (DCCRN) architecture to enhance audio signals by suppressing background noise. The system further leverages a pre-trained contrastive language-audio model (CLAP) to detect audio events and generate corresponding audio event tags. The CLAP model performs zero-shot classification using a predefined set of textual descriptions representing various audio events. In some embodiments, the server device expands the textual description set into candidate terms through keyword extraction and selects the appropriate audio event tags based on an embedding similarity threshold, thereby improving tagging accuracy without requiring task-specific training.

In some embodiments, the system further includes functionality for evaluating the performance of the fine-tuned server-side instance of the audio denoising model using a scale-invariant signal-to-noise ratio improvement (SI-SNRi) metric. The server device is configured to iteratively resume audio sample collection and repeat the fine-tuning process until the SI-SNRi metric meets a predefined release threshold. Upon reaching the threshold, the server transmits the fine-tuned model parameters to the edge device, enabling deployment of the improved model for on-device inference.

An embodiment of the present disclosure provides a method for fine-tuning an audio denoising model, executed by a server device. The method includes receiving an audio sample from an edge device, the audio sample being captured using a microphone. The server device detects one or more audio events within the audio sample, each corresponding to one of a plurality of predefined audio event categories. Based on the detected audio events, the server identifies background noise segments and fine-tunes a server-side instance of the audio denoising model using the identified segments, resulting in updated model parameters. The fine-tuned model parameters are transmitted to the edge device, which uses them to update a corresponding local instance of the model for denoising input audio signals.

In some embodiments, detecting the audio events includes performing audio tagging to assign one or more event tags to the sample. Identifying background noise may involve determining a union set of tagged segments, computing the complement set of un-tagged portions, and selecting the complement as background noise.

In certain embodiments, the method further comprises transmitting the detected audio event tags to a user interface configured to present the tags to a user. The method includes receiving, via the user interface, a user selection indicating one or more audio event tags to be treated as background noise segments. Based on the user selection, the corresponding audio segments are selected and used for fine-tuning the audio denoising model, allowing for user-guided refinement of noise suppression.

In some embodiments, the method for fine-tuning the audio denoising model further includes extracting audio feature embeddings from the identified background noise segments and applying a self-attention mechanism to the extracted embeddings. The self-attention mechanism is conditioned on a selected audio event category to emphasize feature representations relevant to that category, thereby enabling context-aware model fine-tuning. In some embodiments, the self-attention mechanism is utilized only during server-side fine-tuning, while inference on the edge device is performed without the self-attention mechanism to preserve computational efficiency.

In some embodiments, the method for fine-tuning the server-side instance of the audio denoising model includes generating augmented training data by mixing the identified background noise segments with audio recordings corresponding to foreground audio events. The model parameters are then updated based on the augmented training data to improve denoising performance.

In some embodiments, the mixing process is performed at multiple predefined signal-to-noise ratios (SNRs) to enhance the model's robustness across varying acoustic conditions. Additionally, the method may include assembling an augmented training corpus comprising paired clean reference audio and corresponding synthetic mixtures generated by combining the clean audio with the identified background noise segments, enabling supervised learning for noise suppression.

In some embodiments, the method utilizes an audio denoising model based on a Deep Complex Convolution Recurrent Network (DCCRN) architecture, which is well-suited for complex-valued spectral inputs and real-time denoising tasks. The method further includes detecting audio events by employing a pre-trained contrastive language-audio model to generate audio event tags. The contrastive model performs zero-shot classification using a predefined set of textual descriptions of audio events, allowing the system to identify events without requiring task-specific retraining. In some embodiments, the method expands the textual description set into candidate terms through keyword extraction and selects relevant audio event tags based on an embedding similarity threshold, thereby improving the flexibility and precision of event detection.

In some embodiments, the method further includes evaluating a scale-invariant signal-to-noise ratio improvement (SI-SNRi) metric for the fine-tuned server-side instance of the audio denoising model. The server device resumes audio sample collection and repeats the fine-tuning process until the SI-SNRi metric satisfies a predefined release threshold. Upon reaching the threshold, the method includes transmitting the fine-tuned model parameters to the edge device for deployment, thereby ensuring that the updated model achieves a desired level of denoising performance before distribution.

### BRIEF DESCRIPTION OF THE DRAWINGS

The present disclosure can be more fully understood by reading the subsequent detailed description and examples with references made to the accompanying drawings, wherein:

FIG. 1 an audio denoising system configured to perform steps of an audio de-noising model (ADM), according to an embodiment of the present disclosure;

FIG. 2 shows a block diagram of an audio denoising process according to an embodiment of the present disclosure; and

FIG. 3A illustrates a flow diagram of a method for performing ADM, in accordance with an embodiment of the present disclosure;

FIG. 3B illustrates the corresponding data flow of the method shown in FIG. 3A;

FIG. 4 shows a flow diagram illustrating a method for identifying background noise segments, according to an embodiment of the present disclosure;

FIG. 5 shows a flow diagram illustrating a method for user-assisted selection of background noise segments, according to an embodiment of the present disclosure;

FIG. 6 illustrates a user interface corresponding to the method of FIG. 5;

FIG. 7 shows a data flow diagram illustrating a method for feature-based fine-tuning of a server-side ADM, according to an embodiment of the present disclosure; and

FIG. 8 shows a data flow diagram illustrating a process for generating augmented training data and performing server-side fine-tuning of the audio denoising model, according to an embodiment of the present disclosure.

### DETAILED DESCRIPTION

The following description is made for the purpose of illustrating the general principles of the disclosure and should not be taken in a limiting sense. The scope of the disclosure is best determined by reference to the appended claims.

To address the practical difficulties of maintaining denoising performance across diverse and changing acoustic environments while operating under the computational constraints of edge devices, the disclosed system enables cooperative optimization between an edge device and a server device. The edge device executes a local instance of an audio de-noising model to process input audio signals, while the server device analyzes audio samples collected from the edge device to identify background noise characteristics. The server device fine-tunes a corresponding server-side model using the identified noise segments and transmits fine-tuned parameters to the edge device. By updating the local model with these parameters, the system allows for continuous and adaptive improvement of denoising performance without requiring manual intervention or full retraining on the edge device.

Although this architecture primarily focuses on edge-to-server cooperation for adaptive audio denoising, the underlying principles may be extended to other types of machine learning models and environmental adaptation scenarios. The present disclosure ad-dresses these challenges through multiple embodiments, which will be described hereinafter.

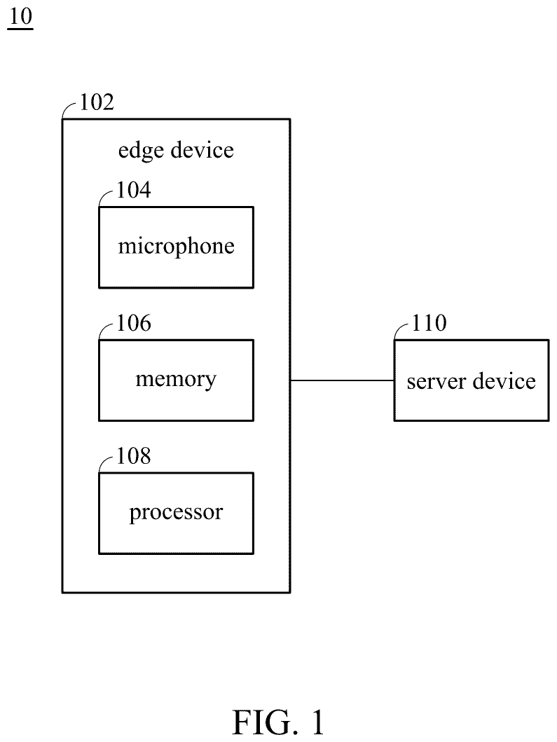

FIG. 1 shows an audio denoising system 10 configured to perform steps of an audio denoising model (ADM), according to an embodiment of the present disclosure. The audio denoising system 10 includes an edge device 102 and a server device 110, which may be connected through a wired or wireless communication link, such as Ethernet, Wi-Fi, 5G, or other suitable network interfaces, but the present disclosure is not limited thereto. In some embodiments, the ADM may be executed cooperatively between the edge device 102 and the server device 110, but is not limited thereto.

In some embodiments, the edge device 102 may be implemented as any computing apparatus configured to capture and process audio signals in real time, such as a smart speaker, wearable device, mobile phone, in-vehicle infotainment system, or an embedded module integrated within an Internet-of-Things (IoT) endpoint. The server device 110 may be implemented as a cloud-based computing platform, a data center server, or an edge cloud node having greater computational and storage resources. In certain embodiments, the edge device 102 and the server device 110 may cooperatively perform distributed inference and model update operations, where the edge device focuses on real-time denoising while the server device performs large-scale model optimization.

The edge device 102 includes a microphone 104. The microphone 104 is configured to acquire an audio sample from the environment and convert the captured sound into an electrical or digital signal suitable for processing. The microphone 104 may be directional, omnidirectional, or array-based, and may include pre-processing circuitry such as amplifiers, analog-to-digital converters, or noise suppression filters, but the present disclosure is not limited thereto. The microphone 104 is operatively coupled to a processor 108, enabling the edge device to receive input audio for real-time or near real-time denoising. In certain embodiments, multiple microphones 104 may be used to support spatial audio capture or beamforming to improve denoising performance.

The edge device 102 further includes a memory 106 storing the local instance of the ADM. The local instance may be implemented using one or more machine learning architectures, such as a convolutional neural network (CNN), recurrent neural network (RNN), long short-term memory (LSTM) network, transformer-based network, or any suitable hybrid architecture trained to suppress background noise from input audio signals, but the present disclosure is not limited thereto.

In some embodiments, the memory 106 may include volatile memory, non-volatile memory, or a combination thereof, and may store model parameters, weights, biases, and configuration data required for executing the audio denoising model. The memory 106 may further store intermediate feature representations, temporary audio buffers, and other runtime data used during real-time inference. In certain embodiments, the memory 106 may be configured to allow the local model to be updated with fine-tuned parameters received from the server device 110, enabling adaptive improvement of denoising performance based on environmental audio characteristics.

The edge device 102 further includes a processor 108. The processor 108 may be implemented as a central processing unit (CPU), a graphics processing unit (GPU), a neural processing unit (NPU), a digital signal processor (DSP), a microcontroller unit (MCU), a field-programmable gate array (FPGA), an application-specific integrated circuit (ASIC), or a combination thereof, but the present disclosure is not limited thereto. The processor 108 is operatively coupled to the memory 106 and the microphone 104, and is configured to execute the local instance of the audio denoising model to perform denoising on the input audio signal in real time or near real time. In certain embodiments, the processor 108 may additionally manage buffering of audio samples, perform feature extraction, handle model inference operations, and generate a denoised output audio stream for subsequent playback, transmission, or storage. The processor 108 may also facilitate updating of the local audio denoising model with fine-tuned parameters received from a server device 110, enabling adaptive adjustment of denoising performance based on environmental conditions or user-specific requirements.

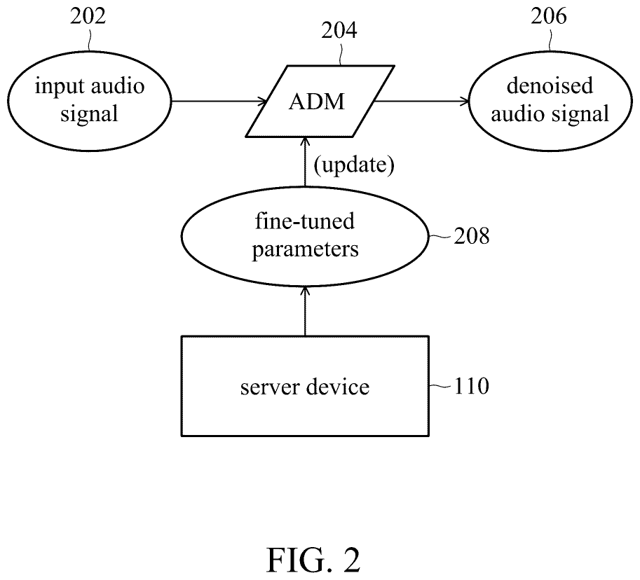

A flow diagram illustrating the operation of the ADM, including parameter updates received from the server device 110, is shown in FIG. 2 and is described in further detail below.

FIG. 2 illustrates a block diagram of an audio denoising process performed using an audio denoising model (ADM) 204, which may be implemented and executed on the edge device 110 illustrated in FIG. 1, in accordance with an embodiment of the present disclosure. The ADM 204 is configured to receive an input audio signal 202, such as a digitized signal captured by a microphone, and generate a denoised audio signal 206 as output. The ADM 204 may utilize one or more machine learning models stored locally on the edge device to remove background noise or unwanted acoustic components from the input signal. In certain embodiments, the ADM 204 may operate in real time or near real time, thereby providing low-latency audio enhancement suitable for live communication, streaming, or other audio applications. Further details of the adaptive parameter update process between the edge device and the server device are described below.

The ADM 204 is further configured to receive fine-tuned parameters 208 from a server device 110. The fine-tuned parameters 208 may be derived from cloud-based training or adaptation processes that take into account user-specific preferences, environmental conditions, or contextual audio characteristics. Upon receipt of the fine-tuned parameters 208, the ADM 204 may update its internal weights, biases, or other model parameters to improve denoising performance. This update mechanism enables adaptive, on-device inference without requiring full retraining or replacement of the local model, thereby enhancing both personalization and computational efficiency.

In some embodiments, the updated parameters may be transmitted periodically, on demand, or in response to detected changes in environmental noise patterns. By combining cloud-assisted model refinement with edge-based inference, the system supports robust, scalable, and responsive noise suppression across diverse acoustic environments.

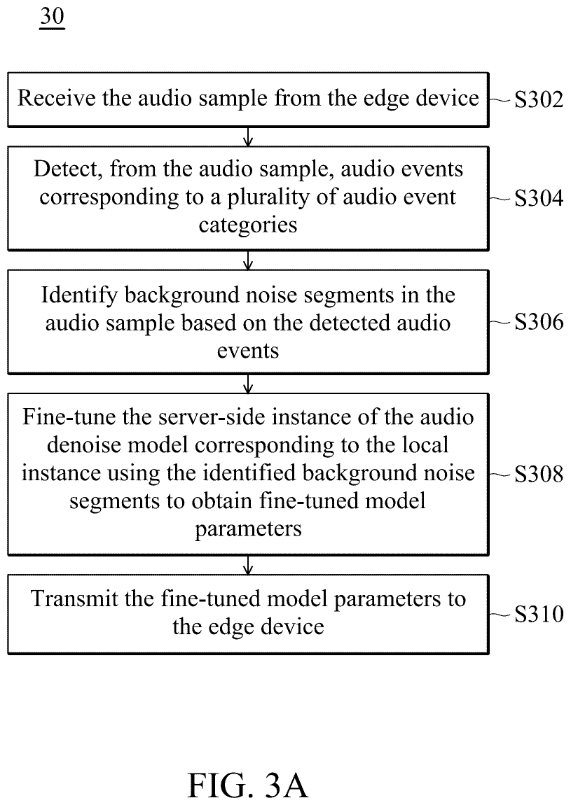

The steps executed by the audio denoising system 10 for performing adaptive fine-tuning of an ADM will be described in detail below with reference to FIG. 3A and FIG. 3B. The following description provides an example implementation of the method and system architecture.

FIG. 3A illustrates a flow diagram of a method 30 for performing adaptive fine-tuning of an audio denoising model (ADM), in accordance with an embodiment of the present disclosure. FIG. 3B illustrates the corresponding dataflow of the method 30 shown in FIG. 3A. The process begins in step S302, in which an audio sample 304 is received from the edge device 102. The audio sample 304 may contain a combination of foreground speech, background noise, and various transient or environmental sounds captured by one or more microphones operatively coupled to the edge device 102.

At step S304, the system performs detection of one or more audio events within the received audio sample 304. In one embodiment, as shown in FIG. 3B, a classifier module analyzes the audio sample 304 to categorize different sound segments and determine the corresponding audio event category for each audio event. In the example shown in FIG. 3B, audio event 306A corresponds to animal sounds (e.g., meowing), audio event 306B corresponds to wind sound, and audio event 306C corresponds to human speech. Each audio event 306A, 306B, 306C may be identified using one or more machine learning models, signal processing techniques, or rule-based logic to recognize specific sound patterns, spectral characteristics, or temporal features associated with the corresponding audio event category. The classification of these audio events allows the system to distinguish foreground content from background noise, facilitating subsequent identification of noise segments for adaptive model fine-tuning.

In some embodiments, the server device 110 detects the audio events within an audio sample 304 by performing audio tagging on the received audio sample 304. In particular, the system assigns one or more audio event tags to segments of the audio sample 304, wherein each audio event tag corresponds to a specific audio event category, such as animal sounds, wind sound, human speech, or machinery noise. The audio tagging process may utilize machine learning models, signal processing techniques, or a combination thereof to analyze spectral, temporal, or other acoustic features of the audio sample. This tagging enables subsequent identification of background noise segments for adaptive model fine-tuning.

In some embodiments, the server device 110 detects the audio events within an audio sample 304 using a pre-trained contrastive language-audio model (CLAP). The CLAP model is configured to perform zero-shot classification by aligning audio feature embeddings with textual embeddings corresponding to a predefined set of textual descriptions of audio events. Through this embedding alignment, the server device 110 generates audio event tags without requiring task-specific retraining, thereby enabling efficient classification of diverse acoustic environments.

In certain embodiments, the server device 110 further expands the predefined set of textual descriptions into a broader collection of candidate terms by performing keyword extraction or semantic expansion. The resulting candidate terms are then evaluated using an embedding similarity threshold to select the final audio event tags. By employing this contrastive embedding-based detection process, the system enables flexible and scalable recognition of diverse acoustic events under zero-shot conditions, facilitating adaptive audio analysis in dynamic environments.

At step S306, background noise segments 308 are identified from the audio sample 304 based on the detected audio events. The identification process may include filtering out segments classified as foreground speech or other user-relevant content, and retaining only segments representing persistent or transient background noise. In some embodiments, the identification process further involves spectral energy analysis, temporal masking, or clustering of feature embeddings to isolate consistent noise patterns.

At step S308, the background noise segments 308 identified in step S306 are input into a server-side instance of the ADM 310 to perform fine-tuning. The server-side ADM 310 may update its internal parameters, including model weights, biases, or other model parameters, based on the characteristics of the identified background noise segments 308. The resulting updated parameters constitute fine-tuned model parameters, which reflect the model's adaptation to the specific acoustic conditions represented by the background noise segments. In some embodiments, the fine-tuning process involves training the server-side ADM 310 using one or more machine learning techniques, such as gradient-based optimization, to minimize a loss function that measures the discrepancy between the denoised output and a reference or target audio signal.

At step S310, the server device 110 transmits the fine-tuned model parameters 312 to the edge device 102. Upon receipt, the edge device 102 updates its local instance of the ADM 204 using the received fine-tuned model parameters 312. This update allows the edge device 102 to achieve improved denoising performance adapted to the specific environmental conditions observed in the audio samples it captured.

In some embodiments, the process illustrated in FIGS. 3A and 3B may be performed periodically, on demand, or automatically in response to detected acoustic changes or degradation in denoising quality. The described architecture leverages the computational resources of the server device 110 for data-intensive fine-tuning, while the edge device 102 performs low-latency inference locally. This design enables cloud-assisted adaptation of the ADM while minimizing communication overhead. In certain embodiments, privacy-preserving operation may be achieved by ensuring that only processed embeddings or model updates, rather than raw audio data, are transmitted between the edge and server devices.

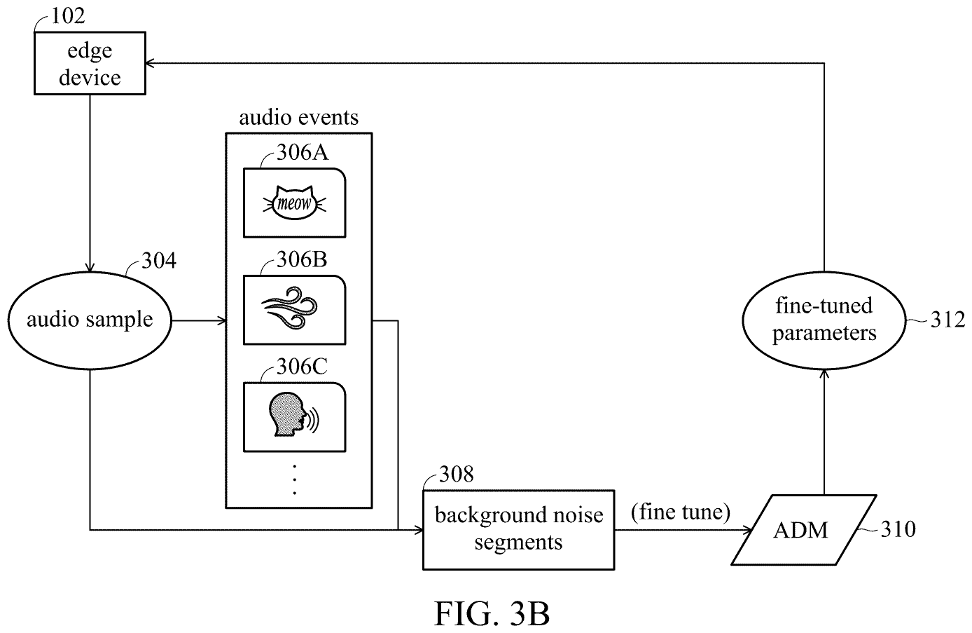

FIG. 4 shows a flow diagram 40 illustrating a method for identifying background noise segments 308, according to an embodiment of the present disclosure. The process includes steps S402, S404, and S406. In step S402, the server device 110 determines the union of all portions of the audio sample 304 that have been assigned one or more audio event tags. This step ensures that all segments corresponding to detected foreground audio events, such as human speech, animal sounds, wind sound, or machinery sound, are accounted for and grouped together.

In step S404, the server device 110 computes a complement set comprising the portions of the audio sample 304 that are not included in the union determined in step S402. The complement set represents portions of the audio that are not associated with any detected foreground audio events, and therefore likely correspond to background noise.

In step S406, the server device 110 selects the complement set as the background noise segments 308 for subsequent processing and fine-tuning of the server-side audio denoising model 310. By employing this selective identification approach, the system accurately extracts background noise segments representative of the acoustic environment of the edge device, thereby providing precise and context-specific training material for fine-tuning the server-side audio denoising model. As a result, the audio denoising model 310 achieves enhanced capability in suppressing unwanted background noise while preserving desired speech or signal content, leading to improved denoising performance in real-world acoustic environments.

In some embodiments, the audio denoising model 310 is based on a Deep Complex Convolution Recurrent Network (DCCRN) architecture. In this configuration, the model processes complex-valued spectrogram representations of the input audio, leveraging convolutional layers to capture local spectral patterns, recurrent layers to model temporal dependencies, and a complex-valued decoder to reconstruct the denoised audio signal. The DCCRN architecture enables the model to jointly consider magnitude and phase information of the audio spectrum, improving noise suppression accuracy while preserving the natural characteristics of the foreground sounds. This architecture can be fine-tuned using the background noise segments 308 identified in steps S402-S406, allowing the server-side instance of the model to adapt to environment-specific noise conditions and maintain high-quality denoising performance during on-device inference at the edge device 102.

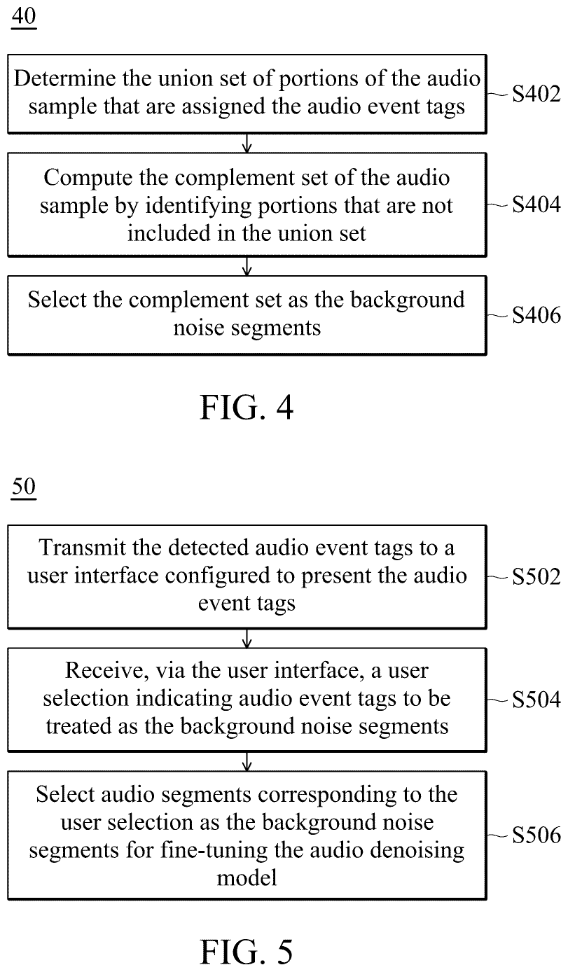

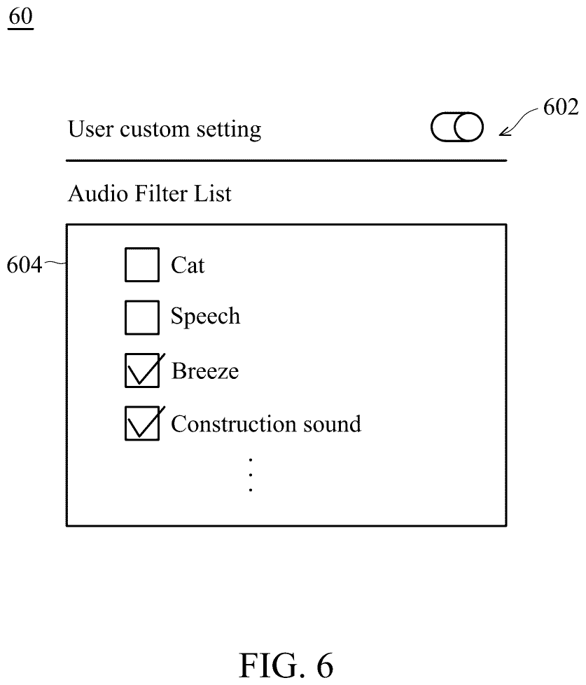

FIG. 5 shows a flow diagram 50 illustrating a method for user-assisted selection of background noise segments 308, according to an embodiment of the present disclosure. The process includes steps S502, S504, and S506. FIG. 6 illustrates a user interface used in the method of FIG. 5, including a button 602 and an audio filter list 604 for interacting with the detected audio event tags.

In step S502, the server device 110 transmits the detected audio event tags to a user interface configured to present the audio event tags to a user. The audio event tags correspond to predefined audio event categories, such as animal sounds, wind sound, human speech, or machinery sound. The user interface, as shown in FIG. 6, may present the tags in a list, graphical display, or other interactive format, including the audio filter list 604 and the toggle 602, enabling the user to review the detected audio events in the captured audio sample 304 and specify which types of sounds are to be treated as background noise or foreground content.

In some embodiments, the user may interact with the interface to manage the audio event tags. For example, the toggle 602 allows the user to enable or disable the custom noise selection feature. When enabled, the audio filter list 604 is expanded to display all detected audio event categories, allowing the user to specify which categories are to be treated as background noise. The user can then select check boxes corresponding to categories that should be treated as background noise. This interactive selection specifies which audio events are to be excluded from the foreground content, providing precise control over the identification of background noise segments 308 for subsequent server-side fine-tuning of the audio denoising model 310.

In step S504, the server device 110 receives the user selection via the interface, indicating which audio event tags are to be treated as background noise segments. The selection may be made through checkboxes, toggles, or other input mechanisms provided by the interface. By allowing the user to specify which audio events should be treated as noise, the system enables customization of the noise suppression process according to user preferences or environmental context.

In step S506, the server device 110 selects audio segments corresponding to the user selection (i.e., the portions of the audio sample 304 that correspond to the user-selected audio event tags) as the background noise segments 308. These selected segments are then used for subsequent fine-tuning of the server-side audio denoising model 310. This user-assisted selection ensures that the audio denoising model 310 effectively removes unwanted noise while preserving desired foreground content, providing both personalization and adaptability across diverse recording environments.

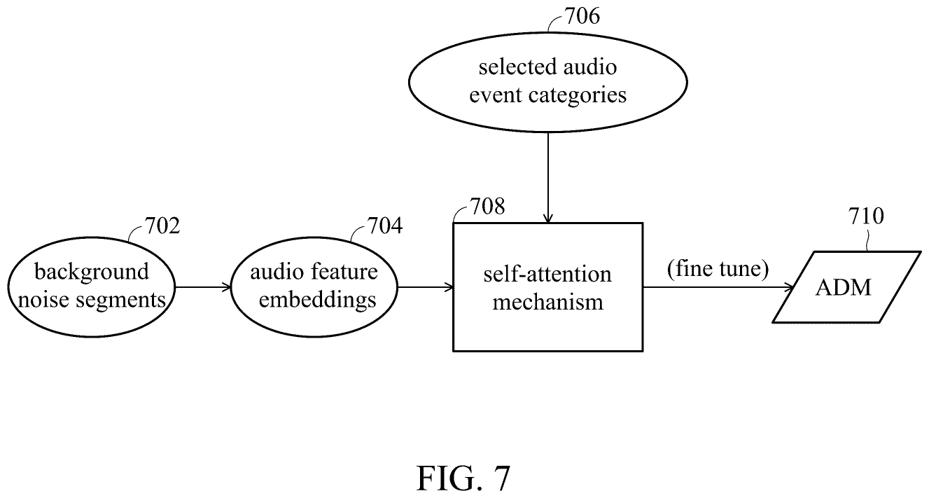

FIG. 7 is a data flow diagram illustrating a method for feature-based fine-tuning of a server-side audio denoising model (ADM) 710, according to an embodiment of the present disclosure. In some embodiments, the server device 110 fine-tunes the server-side ADM 710 by first extracting audio feature embeddings 704 from the background noise segments 702. These embeddings capture spectral, temporal, or other relevant characteristics of the audio signal useful for distinguishing noise from desired foreground content.

The server device 110 then applies a self-attention mechanism 708 to the extracted audio feature embeddings 704. The self-attention mechanism 708 is conditioned on selected audio event categories 706, such as animal sounds, wind sound, human speech, or machinery sound, to emphasize feature representations associated with the selected categories. By emphasizing feature representations associated with the selected categories, the server-side ADM 710 is fine-tuned to focus on noise characteristics relevant to those categories, thereby improving suppression of unwanted background noise while preserving desired foreground content.

This approach enables category-specific adaptation of the server-side ADM 710, supporting more precise and effective denoising in diverse acoustic environments. The model dynamically adjusts to different noise conditions based on the selected audio event categories 706, ensuring that background noise suppression is tailored to the actual acoustic context.

In some embodiments, the self-attention mechanism 708 is applied only during the server-side audio denoising model (ADM) 710. Once fine-tuning is completed, the updated model parameters are transmitted to the edge device 102 for deployment. During on-device inference, the self-attention mechanism is not executed; the local instance of the ADM performs denoising using the optimized parameters, maintaining low computational complexity and real-time performance. This separation between training and inference configurations enables high denoising accuracy with minimal latency and efficient resource utilization on the edge device.

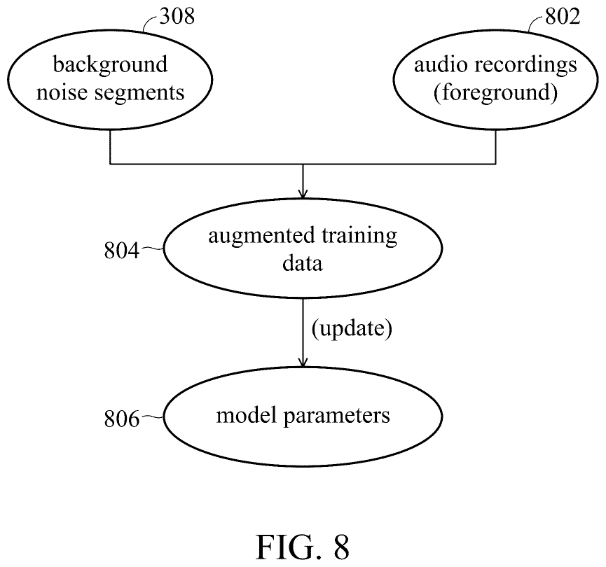

FIG. 8 shows a data flow diagram illustrating a process for generating augmented training data and performing server-side fine-tuning of the audio denoising model 310, according to an embodiment of the present disclosure. As shown, the process begins with the background noise segments 308, which are combined with audio recordings 802 corresponding to foreground audio events previously identified by the server device 110. Data augmentation is applied to the extracted background noise segments 308 to increase the diversity of the training dataset, generating additional samples that reflect both preexisting clean audio content and environmental noise conditions present at the edge device 102. This augmented dataset exposes the server-side model 310 to previously unseen or dynamically changing noise conditions, enabling effective suppression of new target noise.

Supervised learning is performed using paired training data comprising ground truth audio and corresponding synthetic mixtures. The ground truth audio includes pre-recorded clean sounds, such as insect chirping, bird calls, or human speech, while the mixture samples are generated by combining the ground truth audio with the augmented background noise segments 308. In some embodiments, the server device 110 may further construct an augmented training corpus that includes such paired clean reference audio and corresponding synthetic mixtures, thereby improving denoising accuracy and model generalization across diverse recording environments.

Because the audio denoising model 310 has been pre-trained, full retraining is not required. The server device 110 updates the model parameters 806 using the augmented training data 804, balancing the proportion of additional augmented samples with existing training data and controlling the number of iterations to prevent overfitting. In certain embodiments, mixing may be performed at multiple predefined signal-to-noise ratios (SNRs) to further diversify training examples. Through this process, the server-side model 310 adapts to dynamic environmental noise while maintaining stable and generalized denoising performance.

Upon completion of fine-tuning, the server device 110 evaluates a scale-invariant signal-to-noise ratio improvement (SI-SNRi) or other performance metrics based on validation data representative of the target acoustic environment. If the SI-SNRi metric meets or exceeds a predefined release threshold, the fine-tuned model parameters 312 are transmitted to the edge device 102 for deployment. Upon receipt, the edge device updates its local instance of the ADM with the received parameters and resumes real-time inference using the updated model.

If the SI-SNRi metric fails to meet the release threshold, the server device 110 collects additional audio samples, including previously unseen or dynamically changing environmental sounds, and incorporates them into the next fine-tuning cycle. This iterative evaluation and update mechanism ensures continuous improvement of the server-side model 310 and maintains stable, high-quality denoising performance across diverse acoustic environments.

In some embodiments, through this iterative server-side fine-tuning and edge device update process, the audio denoising model achieves enhanced adaptability to environmental noise, while the edge device benefits from personalized, low-latency denoising inference. The system continuously refines the model based on environmental and user-specific data, providing improved noise suppression, speech clarity, and generalized performance against previously unseen noise conditions, without requiring manual configuration or full retraining on the edge device.

In some embodiments, the server device 110 generates augmented training data by randomly sampling contiguous windows from background noise segments of sufficient duration. For example, a background noise segment may span 30 seconds or more, and the server may extract multiple 5-second windows from within this segment to synthesize training examples. These sampled windows are then mixed with foreground audio recordings to produce synthetic mixtures for fine-tuning the server-side audio denoising model. The diversity of sampled windows improves the robustness of the fine-tuned model across varying acoustic conditions.

In some embodiments, the server device 110 applies a self-attention mechanism 708 to audio feature embeddings 704 derived from background noise segments 702. The self-attention mechanism 708 is conditioned on selected audio event categories 706 to emphasize features associated with those categories and to reconstruct purified representations of background noise. The reconstructed purified representations, with non-target content suppressed and target noise features enhanced, are then used as input to fine-tune the server-side instance of the audio denoising model 710.

The rationale for executing the self-attention mechanism 708 on the server side is to extract cleaner and more representative background noise, which serves as high-quality input for fine-tuning. During inference on the edge device 102, the local instance of the ADM 204 operates without the self-attention mechanism, using the fine-tuned parameters 208 received from the server device 110. This separation enables high denoising accuracy with minimal latency and efficient resource utilization on the edge device 102.

As used herein, an “audio event tag” is a label assigned to a portion of an audio sample that corresponds to a predefined audio event category (e.g., wind noise, fan hum, speech). A union set comprises all tagged portions, and a complement set comprises portions not included in the union; the complement may be selected as background noise segments. A “selected audio event category” may be chosen automatically or via a user interface and may influence attention conditioning or noise selection.

According to the present disclosure, the disclosed system and method are not limited to the described embodiments. In some embodiments, the server-side fine-tuning process can be applied to different types of audio denoising models, deployed in various edge computing environments, and adapted to diverse real-world acoustic conditions. Alternative methods for data augmentation, feature extraction, or performance evaluation may also be employed without departing from the principles of the disclosure.

Additionally, the process may include alternative methods for data augmentation, feature extraction, or performance evaluation without departing from the principles of the disclosure. Therefore, the scope of the appended claims should be interpreted broadly to encompass all modifications, variations, and equivalent arrangements that fall within the spirit of the present disclosure.

What is claimed is:

1. An audio denoising system, comprising:
an edge device, comprising:
a microphone, configured to acquire an audio sample from an environment;
a memory, storing a local instance of an audio denoising model; and
a processor, configured to execute the local instance of the audio denoising model to denoise an input audio signal; and
a server device, configured to:
receive the audio sample from the edge device;
detect, from the audio sample, one or more audio events corresponding to a plurality of audio event categories;
identify background noise segments in the audio sample based on the detected audio events;
fine-tune a server-side instance of the audio denoising model corresponding to the local instance using the identified background noise segments to obtain fine-tuned model parameters; and
transmit the fine-tuned model parameters to the edge device;
wherein the processor is further configured to update the local instance of the audio denoising model using the fine-tuned model parameters.

2. The system as claimed in claim 1, wherein the server device detects the one or more audio events by executing steps comprising:
performing audio tagging on the audio sample to assign one or more audio event tags to the audio sample, wherein each audio event tag corresponds to one of the audio event categories.

3. The system as claimed in claim 2, wherein the server device identifies the background noise segments by executing steps comprising:
determining a union set of portions of the audio sample that are assigned the one or more audio event tags;
computing a complement set of the audio sample by identifying portions that are not included in the union set; and
selecting the complement set as the background noise segments.

4. The system as claimed in claim 2, wherein the server device is further configured to:
transmit the detected audio event tags to a user interface configured to present the audio event tags;
receive, via the user interface, a user selection indicating one or more audio event tags to be treated as the background noise segments; and
select audio segments corresponding to the user selection as the background noise segments for fine-tuning the audio denoising model.

5. The system as claimed in claim 1, wherein the server device fine-tunes the server-side instance of the audio denoising model by executing steps comprising:
extracting audio feature embeddings from the background noise segments; and
applying a self-attention mechanism to the extracted audio feature embeddings, the self-attention mechanism being conditioned on a selected audio event category to emphasize audio feature representations associated with the selected audio event category for model fine-tuning.

6. The system as claimed in claim 5, wherein the self-attention mechanism is applied during server-side fine-tuning, and inference on the edge device is executed without the self-attention mechanism.

7. The system as claimed in claim 5, wherein the self-attention mechanism is further configured to reconstruct purified representations of the background noise segments by suppressing non-target features and enhancing features associated with the selected audio event category,
wherein the reconstructed purified representations are used as input to fine-tune the server-side instance of the audio denoising model.

8. The system as claimed in claim 1, wherein the server device fine-tunes the server-side instance of the audio denoising model by executing steps comprising:
generating augmented training data by mixing the identified background noise segments with audio recordings corresponding to foreground audio events; and
updating model parameters of the audio denoising model based on the augmented training data.

9. The system as claimed in claim 8, wherein the server device is configured to mix the identified background noise segments with the audio recordings corresponding to the foreground audio events at multiple predefined signal-to-noise ratios to generate the augmented training data.

10. The system as claimed in claim 8, wherein the server device generates the augmented training data by executing steps comprising:
assembling an augmented training corpus including paired clean reference audio and corresponding synthetic mixtures created by combining the clean reference audio with the identified background noise segments.

11. The system as claimed in claim 1, wherein the audio denoising model is based on a Deep Complex Convolution Recurrent Network (DCCRN) architecture.

12. The system as claimed in claim 1, wherein the server device detects the one or more audio events using a pre-trained contrastive language-audio model (CLAP) to obtain audio event tags,
wherein the contrastive language-audio model is configured to perform zero-shot classification based on a set of textual descriptions of the audio events.

13. The system as claimed in claim 12, wherein the server device is configured to expand the set of textual descriptions into candidate terms by keyword extraction and to select the audio event tags based on an embedding similarity threshold.

14. The system as claimed in claim 1, wherein the server device is further configured to evaluate a scale-invariant signal-to-noise ratio improvement (SI-SNRi) metric for the fine-tuned server-side instance;
wherein the server device is further configured to resume audio sample collection and repeat fine-tuning until the SI-SNRi metric meets a release threshold; and
wherein the server device transmits the fine-tuned model parameters to the edge device in response to the SI-SNRi metric meeting the release threshold.

15. The system as claimed in claim 1, wherein the server device is further configured to:
generate augmented training data by randomly sampling contiguous windows from a background noise segment of at least a threshold duration; and
use the sampled windows as the identified background noise segments to fine-tune the server-side instance of the audio denoising model.

16. A method for fine-tuning an audio denoising model, executed by a server device, the method comprising:
receiving an audio sample from an edge device, wherein the audio sample is acquired by the edge device using a microphone;
detecting one or more audio events from the audio sample corresponding to a plurality of audio event categories;
identifying background noise segments in the audio sample based on the detected audio events;
fine-tuning a server-side instance of the audio denoising model using the identified background noise segments, thereby obtaining fine-tuned model parameters; and
transmitting the fine-tuned model parameters to the edge device;
wherein the fine-tuned model parameters are used by the edge device to update a local instance of the audio denoising model corresponding to the server-side instance, and the local instance of the audio denoising model is executed by the edge device to denoise an input audio signal.

17. The method as claimed in claim 16, wherein the step of detecting the one or more audio events comprises:
performing audio tagging on the audio sample to assign one or more audio event tags to the audio sample, wherein each audio event tag corresponds to one of the audio event categories.

18. The method as claimed in claim 17, wherein the step of identifying the background noise segments comprises:
determining a union set of portions of the audio sample that are assigned the one or more audio event tags;
computing a complement set of the audio sample by identifying portions that are not included in the union set; and
selecting the complement set as the background noise segments.

19. The method as claimed in claim 17, further comprising:
transmitting the detected audio event tags to a user interface configured to present the audio event tags;
receiving, via the user interface, a user selection indicating one or more audio event tags to be treated as the background noise segments; and
selecting audio segments corresponding to the user selection as the background noise segments for fine-tuning the audio denoising model.

20. The method as claimed in claim 16, wherein the step of fine-tuning the server-side instance of the audio denoising model comprises:
extracting audio feature embeddings from the background noise segments; and
applying a self-attention mechanism to the extracted audio feature embeddings, wherein the self-attention mechanism is conditioned on a selected audio event category to emphasize audio feature representations associated with the selected audio event category for model fine-tuning.

21. The method as claimed in claim 20, wherein the self-attention mechanism is applied during server-side fine-tuning, and inference on the edge device is executed without the self-attention mechanism.

22. The method as claimed in claim 20, wherein the self-attention mechanism is further configured to reconstruct purified representations of the background noise segments by suppressing non-target features and enhancing features associated with the selected audio event category,
wherein the reconstructed purified representations are used as input to fine-tune the server-side instance of the audio denoising model.

23. The method as claimed in claim 16, wherein the step of fine-tuning the server-side instance of the audio denoising model comprises:
generating augmented training data by mixing the identified background noise segments with audio recordings corresponding to foreground audio events; and
updating model parameters of the audio denoising model based on the augmented training data.

24. The method as claimed in claim 23, further comprising:
mixing the identified background noise segments with the audio recordings corresponding to the foreground audio events at multiple predefined signal-to-noise ratios to generate the augmented training data.

25. The method as claimed in claim 23, wherein the step of generating the augmented training data comprises:
assembling an augmented training corpus including paired clean reference audio and corresponding synthetic mixtures created by combining the clean reference audio with the identified background noise segments.

26. The method as claimed in claim 16, wherein the audio denoising model is based on a Deep Complex Convolution Recurrent Network (DCCRN) architecture.

27. The method as claimed in claim 16, wherein the step of detecting the one or more audio events comprises:
using a pre-trained contrastive language-audio model to obtain audio event tags;
performing zero-shot classification based on a set of textual descriptions of the audio events, wherein the contrastive language-audio model is configured to identify the audio events from the textual descriptions.

28. The method as claimed in claim 27, further comprising:
expanding the set of textual descriptions into candidate terms by keyword extraction; and
selecting the audio event tags based on an embedding similarity threshold.

29. The method as claimed in claim 16, further comprising:
evaluating a scale-invariant signal-to-noise ratio improvement (SI-SNRi) metric for the fine-tuned server-side instance;
resuming audio sample collection and repeating fine-tuning until the SI-SNRi metric meets a release threshold; and
transmitting the fine-tuned model parameters to the edge device in response to the SI-SNRi metric meeting the release threshold.

30. The method as claimed in claim 16, further comprising:
generating augmented training data by randomly sampling contiguous windows from a background noise segment of at least a threshold duration; and
using the sampled windows as the identified background noise segments to fine-tune the server-side instance of the audio denoising model.
